(19) United States
(12) Patent Application Publication
(10) Pub. No.: US 2005/0096017 A1
(43) Pub. Date: May 5, 2005

(54) Method for providing requested MBMS service to UEs that failed to receive paging message in a mobile communication system supporting MBMS service

(75) Inventor: Soeng-Hun Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/912,975

(22) Filed: Aug. 6, 2004

(30) Foreign Application Priority Data
Aug. 6, 2003 (KR) 2003-54411

(51) Int. Cl. H04M 11/00

(52) U.S. Cl. 455/414.1; 455/414.2

(57) ABSTRACT

Disclosed is a method for providing an MBMS service in a mobile communication system, which enables a UE to receive a specific MBMS service when the UE failed to receive a corresponding MBMS call message after requesting the specific MBMS service. After receiving period information for confirming information indicating whether the MBMS service is available in a cell where the UE is located, the UE receives the MBMS service by periodically receiving a control message including the information indicating whether the MBMS service available, according to the period information.

### PRIORITY

This application claims priority to an application entitled “METHOD FOR PROVIDING REQUESTED MBMS SERVICE TO UES THAT FAILED TO RECEIVE PAGING MESSAGE IN A MOBILE COMMUNICATION SYSTEM SUPPORTING MBMS SERVICE”, filed in the Korean Intellectual Property Office on Aug. 6, 2003 and assigned Serial No. 2003-54411, the contents of which are incorporated herein by reference.

### BACKGROUND OF THE INVENTION

1. Field of the Invention

The present invention relates to a Multimedia Broadcast/Multicast Service (MBMS) in a mobile communication system, and more particularly to a method for providing an MBMS service to User Equipment (UE) that failed to receive a corresponding MBMS paging message after requesting reception of the MBMS service.

2. Description of the Related Art

Along with the development of the communication industry, a CDMA mobile communication system is being developed to provide a packet data service for transmitting a large amount of packet and circuit data as well as conventional voice communication data, and further to provide a multimedia broadcast/communication service for transmitting multimedia data. To support the multimedia broadcast/communication, an MBMS service, which is provided from one or more multimedia data sources to a number of UEs, is under discussion. The MBMS service supports multimedia transmission formats such as real-time images and audio, still image and text data. The MBMS service is capable of providing audio and video data at the same time as the multimedia transmission formats are applied, and requires a large amount of transmission resources. The MBMS service is provided through a broadcast channel since a number of UEs may receive the same MBMS service.

The MBMS service can be provided in a Point To Point (PTP) mode, in which desired MBMS services are provided to individual subscribers, or in a Point To Multipoint (PTM) mode in which the same MBMS service requested by a number of subscribers is provided to the subscribers. Determination of the service mode is based on the number of UEs desiring to receive a single MBMS service or based on transmission power of the network for providing the MBMS service. When the MBMS service is being provided in the PTP or PTM mode, the service mode can be switched from the PTP to PTM modes or from the PTM to PTP on a cell-by-cell basis as the number of UEs or the transmission power varies.

FIG. 1 schematically shows devices that participate in providing an MBMS service in a mobile communication system.

In FIG. 1, UEs 161, 162, 163, 171 and 172 indicate terminals or subscribers capable of receiving MBMS services, and cells (CELL 1 and CELL 2) 160 and 170 indicate Node Bs (also called “base stations”) that transmit MBMS-related data to the LEs. Hereinafter, the terms “Node B” and “cell” will be used interchangeably.

As shown in FIG. 1, only one radio channel for a multimedia service is established between the cell 160 and the LEs 161, 162 and 163. A Radio Network Controller (RNC) 140 controls a number of cells (i.e., Node Bs), and selectively transmits multimedia data to a specific cell. The RNC 140 also controls a radio channel established to provide the MBMS service. A Serving General Packet Radio Service (GPRS) Support Node (SGSN) 130 performs MBMS-related control for each UE. For example, the SGSN manages service billing data of each UE or selectively transmits multimedia data to a specific RNC. A transit network (Transit NW) 120 provides a communication path between a Broadcast/Multicast Service Center (BM-SC) 110 and the SGSN, which may be composed of a Gateway GPRS Support Node (GGSN) and an external network. As a source of MBMS data, the BM-SC 110 is responsible for scheduling the MBMS data.

Although not shown in FIG. 1, a Home Location Register (HLR) is connected with the SGSN 130 to authenticate UEs that have requested the MBMS service.

As shown in FIG. 1, the MBMS data stream is transferred to the UEs 161, 162, 163, 171 and 172 via the transit network 120, the SGSN 130, the RNC 140 and the cells 160 and 170. A number of SGSNs may exist for an MBMS service, and a number of RNCs may exist for each of the SGSNs. Each SGSN transmits the MBMS data selectively to the RNCs, and each RNC transmits the MBMS data selectively to the cells. To transmit the MBMS data only to selected RNCs, the SGSN stores an RNC name list of RNCs to which the MBMS data stream is to be transmitted, and, to transmit the MBMS data only to selected Node Bs, the RNC stores a cell name list of cells to which the MBMS data stream is to be transmitted.

FIG. 2 is a process flow diagram showing how an MBMS service is provided to UEs.

To provide an MBMS service to UEs, an SGSN first transfers basic information of MBMS services to the UEs via an RNC in a service announcement procedure of step 200. The basic information includes, for example, IDs of MBMS services to be provided to the UE, the time to start the MBMS services, and the duration of the MBMS services. The MBMS ID may include a multicast IP address and an Access Point Name (APN).

When the UEs obtain the basic information of the MBMS services through the announcement procedure, and detect availability of an MBMS service which the UEs desire to receive, the UEs request reception of the desired MBMS service from higher network nodes at step 210. That is, the UEs perform a service request procedure (hereinafter referred to as a “joining procedure”) at step 210. Specifically, the joining procedure is a process in which a UE informs the SGSN of an MBMS service, which the UE desires to receive, and the SGSN performs authentication of the UE and informs the UE of whether the UE can receive the desired MBMS service.

In the joining procedure of step 210, the UE transmits an Activate MBMS Context Request message to the SGSN. After detecting that the UE desires to receive the MBMS service, the SGSN transmits an Activate MBMS Context Accept message to the UE in response to the Activate MBMS Context Request message. In the joining procedure, the SGSN stores names and locations of UEs desiring to receive the MBMS service.

If the BM-SC 110 informs the SGSN of the start of the MBMS service, the SGSN transmits, at step 215, a session start message to RNCs corresponding to the UEs that have requested the MBMS service when the MBMS service is starting up.

At step 220, the RNC transmits an MBMS paging message through a common channel such as a Secondary-Common Control Channel (S-CCPCH) to page the UEs desiring to receive the MBMS service. Since the paging message is transmitted to page a plurality of UEs, the paging procedure of step 220 is referred to as “group paging”, as compared to the conventional paging.

Since the UEs can be in any state (i.e., an idle mode, a Cell_PCH state, a URA_PCH state, or a Cell_DCH state) until the MBMS service is provided to the UEs after the UEs perform the joining procedure at step 210, the MBMS paging message must be transmitted to the UEs so that all the UEs can receive the message irrespective of their states.

Therefore, the RNC needs to transmit a paging indicator channel before transmitting the MBMS paging message, so as to notify the UEs in the idle mode, in the Cell_PCH state, or in the URA_PCH state that the UEs must monitor channels through which the MBMS paging message is to be transmitted.

In detail, the states of the UE are mainly divided into an idle mode and a connected mode in 3GPP. The connected mode is classified into four states according to the type of a downlink channel receivable by the UE, Quality of Service (QoS) thereof, and the type of an uplink channel transmittable by the UE. The four states are a UTRAN Register Area Paging Channel (UTRAN-PCH) state, a Cell_PCH state, a Cell_FACH state, and a Cell_DCH state. Common paging is used for UEs in the idle state, the Cell_PCH state, or the URA_PCH state, and dedicated paging is used for UEs in the Cell_PCH state or the URA_PCH state.

The following is a description of the UE states.

(1) Cell_DCH state: A UE in this state transmits and receives data to and from the UTRAN/CN in the uplink and downlink using a DCH transmitted through a DPCH, and does not receive or transmit common channels other than the DCH. However, the UE can also receive a Forward Access Channel (FACH) other than the DCH if the UE is using a special function. A paging message transmitted through the DCH is used to page the UEs in the Cell_DCH state.

(2) Cell_FACH state: UEs in this state receive downstream data through an FACH and transmit upstream data through an RACH. The UEs continually receive an S-CCPCH to check whether an FACH allocated to them is received. When an upstream data to be transmitted is present, the UEs transmit the data through an RACH after performing a channel acquisition process. A paging message transmitted through the DCH is used to page the UEs in the Cell_FACH state, as with the UEs in the Cell_DCH state.

(3) Cell_PCH state: UEs in this state monitor a Paging Indicator Channel (PICH).

A System Information Block (SIB) of a BCH contains information of the other channels including the FACH. By checking the BCH, the UE can obtain the PICH information and then receive the PICH signal. The paging is an overall procedure for paging the UEs. When the RNC pages a UE, Discontinuous Reception (DRX) may be used to minimize power consumption of the UE.

In the DRX mode, the UE turns on its receiver to receive a paging message only at preset times that have been prescribed between the UE and the CN. In other words, the UE uses the DRX mode to turn the receiver on only at the preset times and to turn it off at the other times, thereby minimizing power consumption.

More specifically, the UE receives a Paging Indicator Channel (PICH) signal on a Paging Occasion (PO), and receives a paging message transmitted through a PCH if a Paging Indicator (PI) included in the received PICH signal is set to 1.

At step 230, the UEs, which have been paged at step 220, transmit response messages to the RNC in response to the paging messages. Using the received response messages, the RNC can determine the number of UEs desiring to receive the MBMS service in each cell and determine a suitable radio channel type of each cell. When a large number of UEs in a cell desire to receive an MBMS service, the MBMS service can be provided through a common channel. When a small number of UEs in a cell desire to receive an MBMS service, the MBMS service can be provided through a dedicated channel established for each UE. The response message transmission may be performed through control message exchange between the RNC and the UEs or through control message exchange between the SGSN and the UEs.

At step 235, the UEs, which have received the MBMS paging message at step 220, receive MBMS RB information required to set up a Radio Bearer (RB) for the MBMS service through an MBMS Control Channel (MCCH).

For example, the MBMS RB information includes information of a radio channel, through which the MBMS service is provided, such as an Orthogonal Variable Spreading Factor (OVSF) code, a Transport Format Command Indicator (TFCI), Radio Link Control (RLC) information, and Packet Data Convergence Protocol (PDCP) information.

The MCCH is a channel for carrying MBMS-related control information. According to the discussion up to now, the MCCH is expected to have the following features.

1. One MCCH is established for each cell.

2. The MCCH is transmitted through a common physical channel such as an S-CCPCH.

3. UEs can obtain, as system information, information of an MCCH established for each cell.

If the UEs, which have been paged at step 220, transmit the response messages at step 230, and acquire the information of the radio channel for providing the MBMS service at step 235 as described above, the UEs are ready to receive the MBMS service requested by them.

At step 240, the RNC provides the MBMS service through the MBMS RB, and the UEs receive the MBMS service through the MBMS RB. While the MBMS service is provided, a control message for supporting the MBMS service can be transmitted trough an MCCH. For example, if a radio bearer parameter for providing a specific MBMS service to UEs is changed, a corresponding MBMS control message is transferred to the UEs through an MCCH. That is, at step 240, the UEs can receive not only MBMS data but also MB MS control messages transmitted through the MCCH.

If the MBMS service session is terminated at a specific time, the SGSN transmits, at step 245, a session stop message, indicating the termination of the MBMS service, to the RNC. If the RNC receives the session stop message, the RNC transmits the session stop message to UEs through an MCCH established for each cell, thereby informing the UEs of the termination of the MBMS service. Upon receipt of the session stop message, the UEs release the MBMS RB and enter a general operating mode.

The following is a brief description of the MBMS session.

The duration of an MBMS service may be divided into a duration in which data is actually transmitted and a duration in which no data is transmitted. If the data transmission duration is completely distinguished from the non-transmission duration, it is desirable that transmission resources be allocated to the transmission duration and no transmission resources be allocated to the non-transmission duration. In the current 3GPP specifications, the data transmission duration of an MBMS service is referred to as a “session”.

The BM-SC can notify each node of the start and end of the session. Each node allocates transmission resources at the session start time and releases the transmission resources at the session end time. One MBMS service may consist of a plurality of sessions and may also consist of a single session. The RNC and the UEs are notified of the start of each session through the session start message (step 215) and the MBMS paging message (step 220), and notified of the end of each session through the session stop messages (steps 245 and 250).

The MBMS paging message of step 220, indicating that the MBMS service will be started soon, must be transmitted so that all UEs located in a corresponding cell can receive the MBMS paging message.

However, some UEs interested in the MBMS service may not receive the MBMS paging message. For example, if a UE is located in a cell change area or suffers from fading when the MBMS paging message is transmitted to the UE, the UE may not receive the MBMS paging message. If the UE fails to receive the MBMS paging message, the UE may completely fail to obtain the session of the MBMS service.

If the UE fails to receive the MBMS paging message, the UE does not receive the MCCH, so that the UE also does not receive the MBMS RB information of the above step 235, resulting in failure to receive the MBMS service.

In other words, if UEs fail to receive the MBMS paging message, the UEs cannot receive the MBMS service since they cannot perceive the start of the MBMS service session. In addition, if all the UEs, which have completed the joining procedure, continually receive the MCCH to perceive the start of the MBMS service irrespective of their states, power consumption of the UE may be increased.

Thus, there is a need to provide a method for enabling a UE, which failed to receive an MBMS paging message, to efficiently receive an MBMS service.

### SUMMARY OF THE INVENTION

Therefore, the present invention has been made in view of the above problems, and it is an object of the present invention to provide a method for enabling a UE to efficiently receive an MBMS service in a mobile communication system.

It is another object of the present invention to provide a method for transmitting a secondary paging message from an RNC to a UE, which has failed to receive a paging message, in a mobile communication system providing an MBMS service.

It is yet another object of the present invention to provide a method for allowing a UE to receive a secondary paging message from an RNC, thereby efficiently receiving an MBMS service in a mobile communication system.

In accordance with one aspect of the present invention, the above and other objects can be accomplished by the provision of a method for receiving a Multicast Broadcast/Multicast Service (MBMS) service by User Equipment (UE) in a mobile communication system supporting MBMS, the method comprising receiving, by the UE, period information required to check information indicating availability of the MBMS service in a cell where the UE is located; and receiving, by the UE, the MBMS service by periodically checking a control message including the information indicating the availability of the MBMS service according to the period information.

In accordance with another aspect of the present invention, there is provided a method for providing an MBMS service to a UE in a mobile communication system supporting MBMS, the method comprising transmitting a first paging message, informing the UE of start of the MBMS service, to the UE; and repeatedly transmitting a second paging message distinguished from the first paging message to the UE according to preset period information after the MBMS service is started.

In accordance with yet another aspect of the present invention, there is provided a method for receiving an MBMS service by a UE in a mobile communication system supporting MBMS, the method comprising receiving, by the UE, a paging message associated with the MBMS service; confirming validity of the received paging message by checking an MBMS paging record parameter including a field indicating whether a previously received paging message exists; and performing an operation for receiving the MBMS service if the paging message is valid.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a network for providing an MBMS service in a mobile communication system;

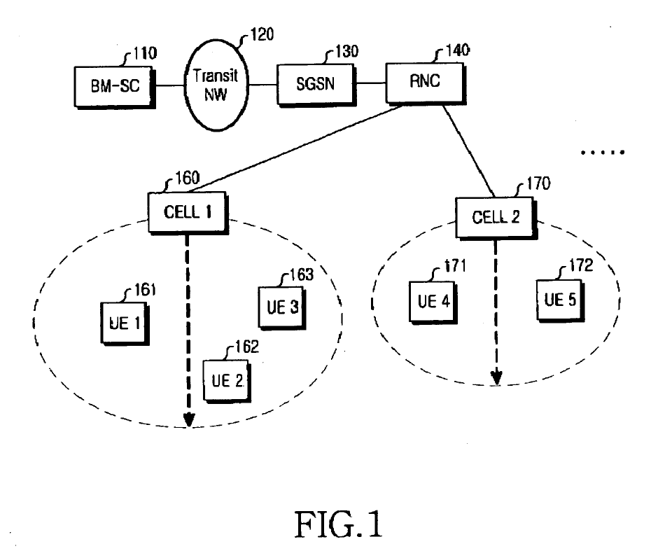

FIG. 2 is a process flow diagram showing a conventional method for providing an MBMS service;

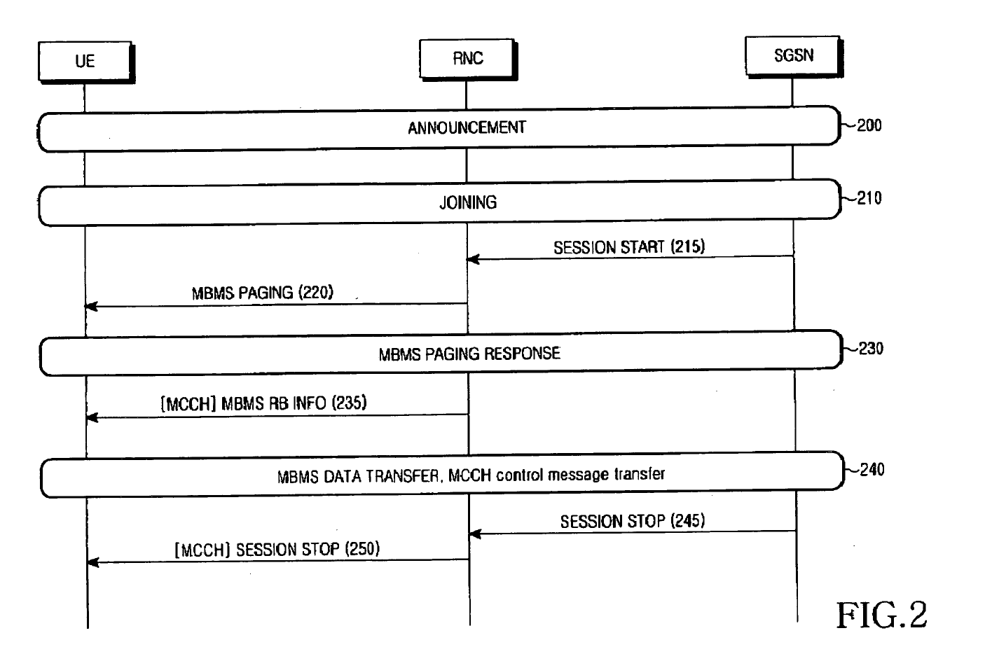

FIG. 3 is a process flow diagram showing a UE-based method for receiving an MBMS service by a UE according to a first embodiment of the present invention;

FIG. 4 is a flow chart showing the operation of a UE according to the first embodiment of the present invention;

FIG. 5 is a process flow diagram showing a network-based method for receiving an MBMS service by a UE according to the second embodiment of the present invention;

FIG. 6 is a flow chart showing the operation of a higher network node according to the second embodiment of the present invention; and

FIG. 7 is a flow chart showing the operation of a UE according to the second embodiment of the present invention.

### DETAILED DESCRIPTION OF THE PREFERRED EMBODIMENTS

Now, preferred embodiments of the present invention will be described in detail with reference to the annexed drawings.

The following description will be given of two exemplary embodiments according to the present invention. Details of messages and signaling used in the present invention are described in the 3GPP specification “3GPP 25.331”.

In the following description of the preferred embodiments according to the present invention, only elements required to understand the operation thereof will be described, and a description of the other elements will be omitted when it may obscure the subject matter of the present invention.

Multimedia Broadcast/Multicast Service (MBMS) is a service for transmitting the same data to a plurality of recipients in a UMTS system, where the recipients share a single radio channel to save radio resources.

The present invention proposes two approaches for enabling a UE to receive an MBMS service after failing to receive a corresponding MBMS paging message in a mobile communication system that provides the MBMS service.

The first approach is based on the UE and the second is based on the network.

First Embodiment

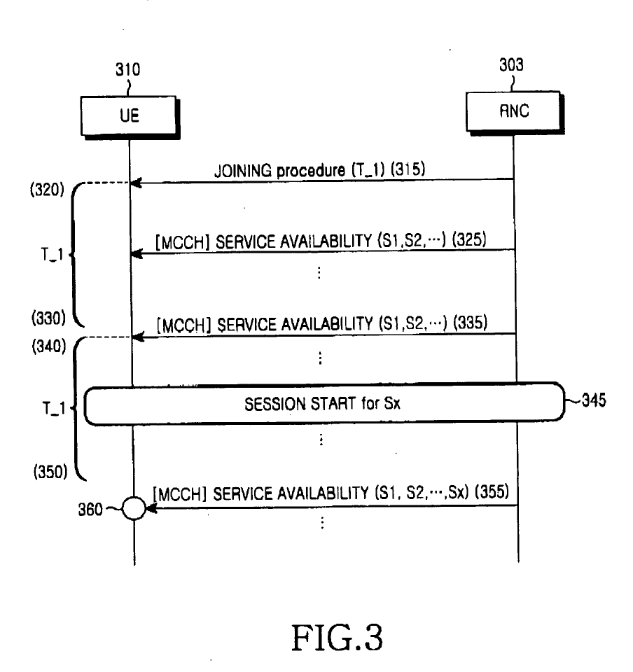

This embodiment provides the first approach based on the UE, in which the UE periodically checks MBMS services provided through an MBMS control channel to confirm an MBMS service requested by the UE, which will be described in detail with reference to FIG. 3.

FIG. 3 is a process flow diagram showing the UE-based method for receiving an MBMS service by a UE according to the first embodiment of the present invention.

A UE 310 detects basic information of MBMS services through an announcement procedure. If an MBMS service X, which the UE 310 desires to receive, is available, the UE 310 performs, at step 315, a joining procedure, in which the UE requests reception of the desired MBMS service X from an RNC 303, and the RNC 303 notifies the UE 310 of whether the UE can receive the MBMS service X. Specifically, at step 315, the UE 310 transmits an Activate MBMS Context Request message to the RNC 303, and the RNC 303 transmits an Activate MBMS Context Accept message to the UE 310 upon receipt of the Activate MBMS Context Request message. The Activate MBMS Context Accept message includes period information for confirmation of control information supporting the MBMS service. That is, the Activate MBMS Context Accept message includes period information (i.e., a timer value) T_1 allowing the UE to confirm the desired MBMS service X in a cell where the UE is located.

Upon completion of the joining procedure, the UE 310 starts, at step 320, its timer according to the received period information T_1, and performs the following operations required before receiving an MBMS paging message.

The UE operates in a general operating mode in which it monitors a Paging Indicator Channel (PICH) to determine when the corresponding MBMS paging message is transmitted.

When moving between cells, the UE acquires system information through a Broadcast Channel (BCH) in a new cell.

On the other hand, the UE performs the following operations required after receiving the MBMS paging message.

The UE operates in a general operating mode in which it receives an MCCH to acquire the corresponding MBMS control information.

When moving between cells, the UE acquires system information through a BCH in a new cell, and receives MBMS-related control information through the MCCH.

At step 320, the UE 310 does not receive the MBMS-related control message through the MCCH since it performs the operations required before receiving the MBMS paging message.

At step 325, the RNC 303 transmits a Service Availability control message containing MBMS service names currently being provided in the corresponding cell. The service availability message is transmitted in each cell. In other words, a service availability message containing names of MBMS services, whose sessions are currently in progress in a corresponding cell, is transmitted on a cell-by-cell basis at intervals of a predetermined period.

At step 330, the UE 310 confirms that the timer of the period T_1 expires, and at step 335, the UE 310 receives a service availability message transmitted through the MCCH.

Referring to the service availability message, the UE 310 confirms that first and second MBMS services S1 and S2 are currently broadcast in the corresponding cell. Until it receives the service availability message, the UE 310 continues to receive the MCCH. In this procedure, the UE 310 receives transport and logical channels carrying an MCCH message to acquire information transmitted through the MCCH.

Through the service availability message received at step 335, the UE 310 confirms that a service ID “Sx” corresponding to an MBMS service X, which the UE desires to receive, is not present. The UE 310 then moves to step 340 to restart the timer according to the period information T_1. The UE 310 then performs the above-mentioned operations required before the reception of the MBMS paging message.

The transmission of the service availability message at steps 325 and 335 may be performed a number of times according to a preset service availability transmission period. That is, the service availability message can be transmitted at intervals of a period preset in the cells.

At step 345, the MBMS service X, which the UE 310 has joined, is started. At this time, the UE 310 does not detect the start of the MBMS service X. Although the MBMS service X is started at step 345, the UE 310 does not detect that the MBMS service X is being provided at step 345 since the UE 310 has failed to receive a previously transmitted MBMS paging message.

If the timer expires according to the preset period information T_1 at step 350, the UE 310 starts an MCCH message reception operation. At step 355, the UE 310 receives a service availability message containing a service ID “Sx” of the MBMS service X requested by the UE 310 in the current cell. At step 360, the UE 310 checks the received service availability message, and starts the operation for receiving the MBMS service X if it detects that the received service availability message contains the service ID “Sx” of the MBMS service X requested by the UE 310. Here, the MBMS service X is being provided in the current cell of the UE 310 at step 360.

The UE 310 operates to receive the MBMS service X in the following manner.

The UE 310 performs the following two operations at the moment of detecting that it has failed to receive the MBMS paging message of the MBMS service X although it has completed a joining procedure of the MBMS service X.

1. Positive operation: The UE 310 requests information, required to receive the MBMS service X, from the RNC 303. The UE 310 transmits this request using a Radio Resource Control (RRC) message.

2. Passive operation: The UE 310 enters an operating mode subsequent to the reception of the MBMS paging message, and then acquires information required to receive the MBMS service X by receiving the MCCH.

As described above, after completing the joining procedure of a specific MBMS service X, the UE 310 receives an MCCH transmitted at intervals of a predetermined period and confirms a service availability message received through the MCCH to check whether the specific MBMS service requested by the UE 310 is being provided in a serving cell. The UE 310 returns to a normal operating mode if the specific MBMS service X is not being provided in the serving cell.

If the specific MBMS service X requested by the UE 310 is being provided, the UE 310 checks an MCCH transmitted from the RNC to acquire information items, required to receive the MBMS service X, or requests the information items from the RNC using an RRC message.

Even if the UE 310 fails to receive the MBMS paging message, the UE 310 detects the start of the MBMS service X within a time T_1 of the preset period information, and then operates to receive the MBMS service X.

The UE can implement the operation of the timer in various ways using the period information T_1 received in the joining procedure. For example, if it is assumed that broadcast time and program information is provided in the announcement procedure, the RNC can know a time interval from when the UE performs the joining procedure to when the broadcast is started. The RNC thus can allow the UE to divide the timer activation duration into durations before and after the session is started, and to adjust the timer values according to the divided durations. For example, period information of the timer for use before the session is started may be set to a longer period than period information of the timer for use after the session is started.

In an alternative method for enabling a UE to receive an MBMS service after failing to receive a corresponding MBMS paging message, at a time when the UE joins the MBMS service, the RNC provides a timer value having a long period for use before the session is started, and a timer value having a short period for use after the session is started, to the UE. The provision of the timer value to the UE may be performed when the UE joins the MBMS service or at other times.

Upon receipt of the timer value, the UE starts the timer. When the timer expires, the UE receives the service availability message, and selects and performs either the operation required before the session is started or the operation required thereafter according to the contents of the received service availability message.

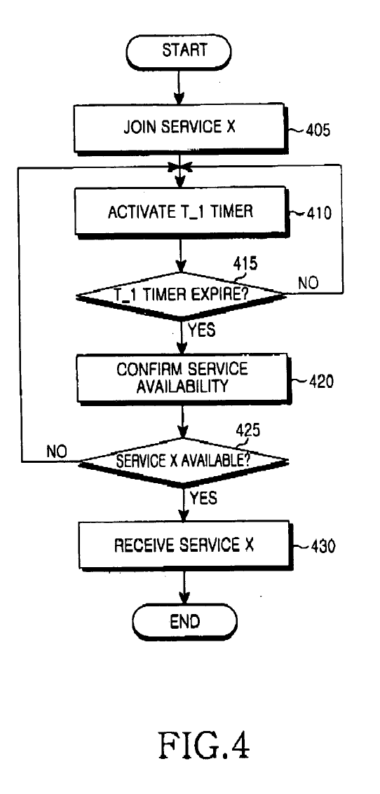

FIG. 4 is a flow chart showing the operation of a UE according to the first embodiment of the present invention.

As shown in FIG. 4, the UE performs, at step 405, a joining procedure of an MBMS service X after detecting basic information of MBMS services through a service announcement procedure. At step 405, the UE detects a timer value T_1 required to support the MBMS service X.

Here, the timer value T_1 is a parameter that is determined for each MBMS service, and calculated by Equation 1.
T_1_{—}X(timer value for MBMS service X)=A(correction factor)×SESSION_PERIOD_{—}X(session period of MBMS service X). [Equation 1]

In this equation, the session period of the MBMS service X “SESSION_PERIOD_X” is proportional to an average session duration of the MBMS service X. Accordingly, the timer value T_1_X for the MBMS service X is proportional to the average session duration of the MBMS service X. A small timer value T_1 is more efficient for MBMS services having a short session duration and a large timer value T_1 is more efficient for MBMS services having a long session duration.

If the timer value T_1_X for the MBMS service X is smaller than a reference value, the timer value T_1 may not be used since power consumption of the UE may be excessive.

The timer value T_1_X is a period, at intervals of which the UE receives an MCCH until it receives the MBMS paging message after performing the joining procedure. Since there is a relatively large time interval between the joining and the MBMS paging message reception, the timer value T_1_X is determined so that the power consumption of the UE is not excessive.

After receiving the timer value T_1 required to receive the MBMS service from the RNC, the UE starts a T_1 timer at step 410. If the T_1 timer expires at step 415, the UE proceeds to step 420. If the T_1 timer is still running, the UE continues the operation of step 410. At step 420, the UE receives a service availability message through the MCCH.

At step 425, the UE checks whether the received service availability message includes a service ID “Sx” of the MBMS service X requested by the UE through the joining procedure. If the received service availability message includes the service ID “Sx” of the MBMS service X, the UE proceeds to step 430. If the received service availability message does not include the service ID “Sx”, the UE returns to step 410 to restart the T_1 timer.

The inclusion of the service ID “Sx” in the service availability message indicates that the MBMS service X is already being provided. Accordingly, at step 430, the UE performs an operation required to receive the MBMS service X. Specifically, the UE requests information items, required to receive the MBMS service X, from the RNC through an RRC message, or receives an MCCH to acquire the required information items.

Second Embodiment

This embodiment provides the second approach based on the network, in which the RNC produces a separate paging message for supporting an MBMS service and enables the UE to receive the MBMS service using the separate paging message.

The MBMS paging message is classified into two types according to the second embodiment of the present invention.

The first type is a general MBMS paging message indicating that an MBMS service will be started soon. That is, the first-type MBMS service message is used to inform the UEs that a session for providing the MBMS service will be started soon.

The second type is a new MBMS paging message introduced according to the present invention. The second-type MBMS paging message is used to inform UEs, which have failed to receive the first-type MBMS paging message, that the MBMS service is being provided, after the session is started. The UEs disregard the second-type MBMS paging message if they have received the first-type MBMS paging message.

When receiving the second-type MBMS paging message after failing to receive the first-type MBMS paging message, the UEs perform an operation required to receive the MBMS service requested by them. That is, the UEs receive the MBMS service by acquiring radio resource information required to receive the MBMS service.

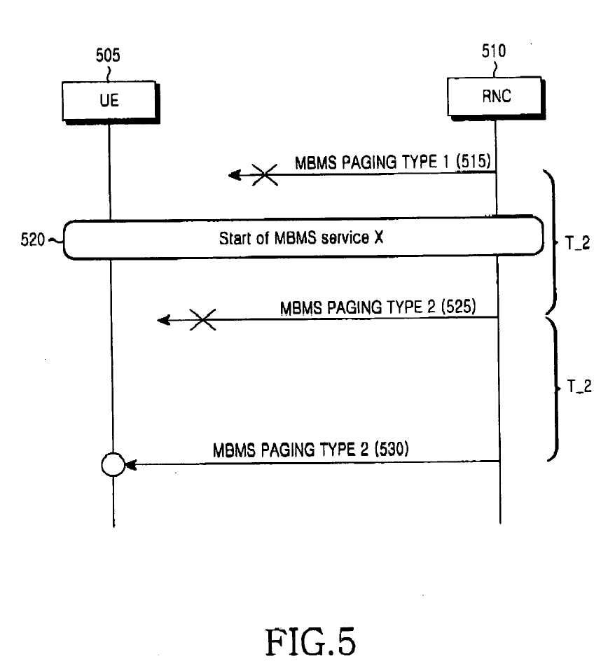

The network-based MBMS service reception method will now be described in more detail with reference to FIG. 5.

FIG. 5 is a process flow diagram showing how the UEs receive the MBMS service in the network-based scheme according to the second embodiment of the present invention.

In FIG. 5, a UE 505 first detects basic information of an MBMS service X through a service announcement procedure. Here, the UE 505 is performing operations required before the MBMS paging message reception, after performing a joining procedure of the MBMS service X.

At step 515, the RNC 510 transmits a first-type MBMS paging message associated with the MBMS service X. Here, the RNC 510 sets period information T_{—}2 for transmission of the MBMS paging message associated with the MBMS service X, and starts its timer according to the set period information when transmitting the first-type MBMS paging message.

However, since it is located in a cell switching area, or due to fading, the UE 505 fails to receive the first-type MBMS paging message for the MBMS service X. Regardless of whether the UE 505 receives the first-type MBMS paging message, the RNC 710 starts, at step 520, providing the MBMS service X to a cell Y where the UE 505 is located.

Since the UE 505 failed to receive the first-type MBMS paging message, the UE 505 also does not detect that the MBMS service X is started at step 520. When the T_2 timer expires at step 525, the RNC 510 produces a second-type MBMS paging message distinguished from the first-type MBMS paging message, and transmits the produced message to the cell Y and restarts the T_2 timer. At step 525, some of the UEs, which have failed to receive the first-type MBMS paging message, receive the second-type MBMS paging message, which is transmitted at intervals of a period T_2. The UEs, which have received the first-type MBMS paging message at step 515, disregard the second-type MBMS paging message even when they receive it.

The UE 505 again fails to receive the second-type MBMS paging message at step 525.

When the T_2 timer expires at step 530, the RNC 510 produces a second-type MBMS paging message, and transmits the produced message to the cell Y and restarts the T_2 timer. If the UE 505 receives the second-type MBMS paging message at step 535, the UE 505 performs the operation for receiving the MBMS service X. According to the second embodiment of the present invention, the RNC 510 retransmits the second-type paging message at intervals of the period T_2 until the session is terminated.

In short, according to the second embodiment of the present invention, the RNC 510 transmits the first-type MBMS paging message as usual, and then transmits the second-type MBMS paging message for UEs, which failed to receive the first-type MBMS paging message, periodically or when required after the session is started.

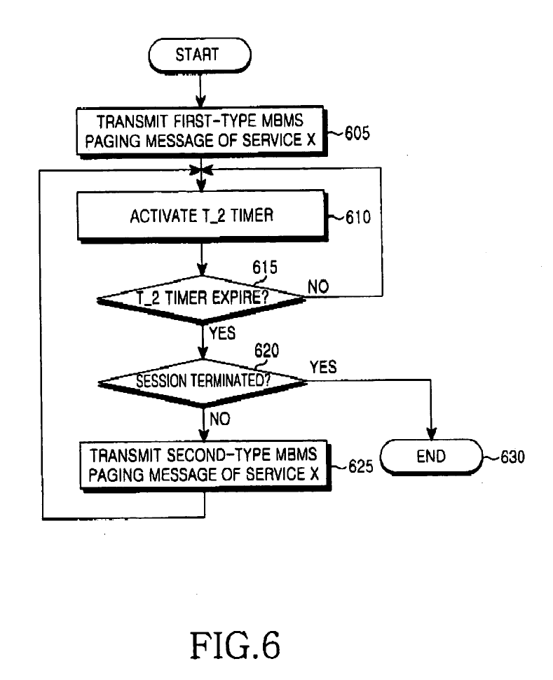

FIG. 6 is a flow chart showing the operation of an RNC according to the second embodiment of the present invention.

In FIG. 6, the RNC provides an MBMS service X to a cell Y If the RNC provides the MBMS service X to a plurality of cells, the MBMS paging message is transmitted to each of the cells.

First, at step 605, the RNC transmits a first-type MBMS paging message for the MBMS service X to the cell Y The first-type MBMS paging message includes parameters such as message type, service ID, etc, where the message type is a parameter indicating the corresponding message type, and the service ID is an ID of the MBMS service which is a target of the first-type MBMS paging message.

At step 610, the RNC starts a T_2 timer at the same time as the transmission of the first-type MBMS paging message to the cell Y A value T_2 of the T_2 timer can be calculated by Equation 2.
T_2_{—}X (timer value for service X)=B (correction factor)×(1/UE_{—}X), [Equation 2]
where “UE_X” denotes the number of UEs located in a cell managed by a specific RNC, among UEs that have completed a joining procedure for the MBMS service X.

It can be seen from Equation 2 that the timer value “T_2_X” is inversely proportional to the number of UEs “UE_X”. The timer value “T_2_X” is set to a large value for MBMS services with a low value of UE_X (i.e., with a small number of joined UEs), whereas it is set to a small value for MBMS services with a high value of UE_X (i.e., with a small number of joined UEs). This is due to the fact that the higher the value “UE_X”, the higher the probability of a UE first-type MBMS paging message reception failure.

If the T_2 timer expires at step 615, the RNC proceeds to step 620, otherwise, the RNC returns to step 610 to activate the T_2 timer. At step 620, the RNC checks whether a session for the MBMS service X is terminated. If the session for the MBMS service X is terminated, the RNC proceeds to step 630 to stop the T_2 timer activated for transmitting the second-type MBMS paging message.

If the session for the MBMS service X is in progress, the RNC proceeds to step 625 to restart the T_2 timer for transmitting the second-type MBMS paging message of the MBMS service X.

At step 625, the RNC transmits the second-type MBMS paging message to the cell Y. Here, the second-type MBMS paging message is transmitted in such a manner that it can be received even by UEs that are performing operations required before the MBMS paging message reception. That is, the second-type MBMS paging message is transmitted in the same manner as the first-type MBMS paging message.

The second-type MBMS paging message includes parameters such as message type, service ID, etc, where the message type is a parameter indicating the corresponding message type, and the service ID is an ID of the MBMS service which is a target of the second-type MBMS paging message.

If the RNC completes the transmission of the second-type MBMS paging message at step 625, the RNC returns to step 610 to retransmit the second-type MBMS paging message.

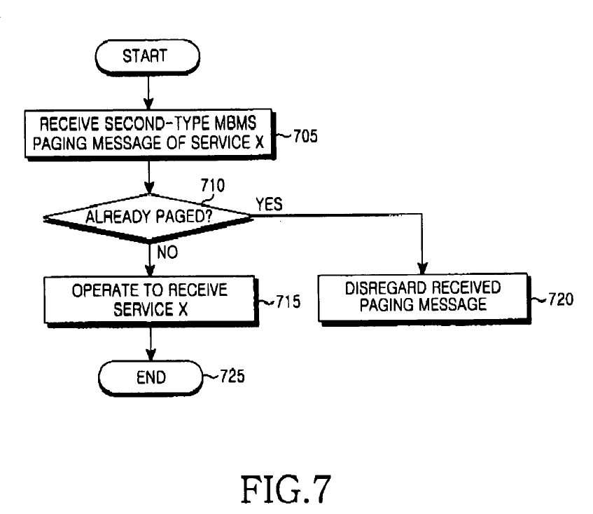

FIG. 7 is a flow chart showing how a UE receives a second-type MBMS paging message according to the second embodiment of the present invention.

In FIG. 7, the UE receives a second-type MBMS paging message associated with an MBMS service X at step 705. The UE determines, at step 710, whether the second-type MBMS paging message is the first MBMS paging message received by the UE. This determination is based a parameter called “MBMS paging record”, which includes two fields “service ID” and “paged”. A “service ID” field contains a service ID of an MBMS service joined by the UE, and a “paged” field, which is provided for each “service ID” field, has a value of either Yes or No.

If the UE receives a first-type MBMS paging message or a second-type MBMS paging message for the MBMS service X, the UE sets a “paged” field corresponding to the MBMS service X to Yes. On the other hand, if the UE receives a session stop message of the MBMS service X, the UE sets the “paged” field corresponding to the MBMS service X to No.

For the determination of step 710, the UE checks a “paged” field corresponding to the MBMS service X which is a target of the received second-type MBMS paging message. If the “paged” field is No, the UE proceeds to step 715, and if Yes, the UE proceeds to step 720.

At step 715, the UE determines that the second-type MBMS paging message received at step 705 is a valid paging message, and performs an operation for receiving the MBMS service X according to the received paging message. The movement of the UE to step 715 indicates that the UE failed to receive a first-type MBMS paging message at some past time and that the MBMS service, which the UE desires to receive, is already being provided. Accordingly, at step 715, the UE starts the operation for receiving the MBMS service requested by the UE. Specifically, at step 715, the UE requests information items, required to receive the MBMS service X, from the RNC through an RRC message. Alternatively, the UE 310 acquires the required information items by receiving an MCCH.

The movement of the UE to step 720 indicates that the UE has already received the first-type MBMS paging message and is currently performing the operation for receiving the MBMS service X. Accordingly, at step 720, the UE disregards the received second-type MBMS paging message.

As apparent from the above description, the present invention has the following features and advantages. After a UE fails to receive a paging message for supporting an MBMS service, the paging message is retransmitted to the UE at intervals of a predetermined period, so that the UE efficiently receives the paging message.

The period, at intervals of which the paging message is transmitted, is set to different values depending on session characteristics. This increases overall efficiency of the mobile communication system supporting MBMS services.

1. A method for receiving a Multicast Broadcast/Multicast Service (MBMS) service by User Equipment (UE) in a mobile communication system supporting MBMS, the method comprising:
receiving, by the UE, period information required to check information indicating availability of the MBMS service in a cell where the UE is located; and
receiving, by the UE, the MBMS service by periodically checking a control message including the information indicating the availability of the MBMS service according to the period information.

2. The method according to claim 1, wherein the control message includes a list of MBMS services available in the cell.

3. The method according to claim 1, further comprising:
starting a timer according to the received period information; and
receiving the control message when the timer expires according to the period information and checking a list of MBMS services available in the cell.

4. The method according to claim 1, wherein the UE performs the reception of the period information through a service request procedure.

5. The method according to claim 4, further comprising:
transmitting an Activate MBMS Context Request message from the UE to a Radio Network Controller (RNC); and
receiving, from the RNC, an Activate MBMS Context Accept message including the period information required to check the information indicating the availability of the MBMS service in the cell.

6. The method according to claim 1, further comprising determining a value of the period information on an MBMS service-by-service basis.

7. The method according to claim 1, further comprising setting the period information to different periods for use before and after transmitting a message indicating start of the MBMS service.

8. A method for providing an MBMS service to a UE in a mobile communication system supporting MBMS, the method comprising:
transmitting a first paging message, informing the UE of start of the MBMS service, to the UE; and
repeatedly transmitting a second paging message distinguished from the first paging message to the UE according to preset period information after the MBMS service is started.

9. The method according to claim 8, wherein the second paging message is transmitted from an RNC to the UE according to the period information, and the second paging message includes an ID of an MBMS service in progress and message type information.

10. The method according to claim 8, wherein the period information has a period value proportional to the number of UEs that have requested reception of the MBMS service.

11. A method for receiving an MBMS service by a UE in a mobile communication system supporting MBMS, the method comprising:
receiving, by the UE, a paging message associated with the MBMS service;
confirming validity of the received paging message by checking an MBMS paging record parameter including a field indicating whether a previously received paging message exists; and
performing an operation for receiving the MBMS service if the paging message is valid.

12. The method according to claim 11, wherein the field indicating whether the previously received paging message exists is provided on an MBMS service-by-service basis.

13. The method according to claim 12, further comprising establishing, by the UE, a Radio Resource Control (RRC) connection to receive the MBMS service.

14. The method according claim 12, further comprising using an MBMS Control Channel (MCCH) message to receive the MBMS service.
